(19) United States
(12) Patent Application Publication
(10) Pub. No.: US 2024/0251375 A1
(43) Pub. Date: Jul. 25, 2024

(54) EFFICIENT GEOLOCATION

(71) Applicant: Absolute Software Corporation, Vancouver (CA)

(72) Inventors: Duc Tri TRAN, Ho Chi Minh City (VN); Quoc Thai Duong NGUYEN, Ho Chi Minh City (VN); Thi Tuyet Suong BUI, Ho Chi Minh City (VN)

(21) Appl. No.: 18/409,207

(22) Filed: Jan. 10, 2024

Related U.S. Application Data
(60) Provisional application No. 63/479,349, filed on Jan. 10, 2023.

(51) Int. Cl. H04W 64/00; H04W 48/08

(52) U.S. Cl. CPC H04W 64/00; H04W 48/08

(57) ABSTRACT

Access point identifiers that are associated with a common location are grouped into sets of three and stored in a document in a database. When the location of a device is required, the access points that it detects are searched for in the database. If a matching set of three access points are found in the database, then the corresponding location is retrieved from the document in which the three access points are found.

### CROSS-REFERENCES TO RELATED APPLICATIONS

This application claims the benefit of priority to U.S. Provisional Application Ser. No. 63/479,349 filed Jan. 10, 2024, the content of which is incorporated herein by reference in its entirety.

### TECHNICAL FIELD

The present disclosure relates to geolocation of an electronic device. In particular, it relates to the use of BSSID (Basic Service Set Identifier) data.

### BACKGROUND

Geolocation services may use third-party application programming interfaces (APIs) to resolve a mobile device's location using detected Basic Service Set Identifiers (BSSIDs) or Media Access Control (MAC) addresses. Fleets of remote devices may need to make hundreds of millions or even billions of API requests annually. The number of API requests increases as the fleets grow and as more location-sensitive features are added to services that manage the devices.

Typically, a device's locations are stored infrequently in a database, if at all. The locations are only used for single device itself.

There is a need for improved methods to geolocate devices.

### SUMMARY

Embodiments of the present invention can use geolocation data more efficiently using device location histories extracted from a large number of documents. A query can be formed based on the database location history of a device to see if there is a location that satisfies some pre-determined, including but not limited to are there a certain number of access points that overlap with a current list of access points detected by a device, having the same public IP, and so on. In this fashion, using the techniques described herein, a potential benefit of embodiments of the invention is that they may reduce the costs of resolving locations.

In an aspect, there is provided a method including receiving a geolocation payload from a first device having a receiver, the geolocation payload including a first plurality of basic service set identifications (BSSID) detected by the first device; and determining a location of the first device by searching, using the first plurality of BSSIDs, a database including a second plurality of BSSIDs and location data associated with the second plurality of BSSIDs.

In an embodiment, the method further includes determining the location using an alternative location lookup if the search does not find location data in the database based on the first plurality of BSSIDs.

In an embodiment, the alternative location lookup is a geolocation API, a location determined using global navigation satellite system (GNSS), or a loca-tion of the OS.

In an embodiment, the method further includes assembling the first plurality of BSSIDs into received BSSID combinations, each received BSSID combination including a first number of BSSIDs from the first plurality of BSSIDs; where the second plurality of BSSIDs are stored as stored BSSID combinations, each stored BSSID combination including the first number of BSSIDs from the second plurality of BSSIDs, and where the determining of the location searches using the received BSSID combinations for matches in the stored BSSID combinations.

In an embodiment, the first number is at least 3.

In an embodiment, the determining of the location of the device searches the database using the received BSSID combinations until at least one received BSSID combination is found.

In an embodiment, the geolocation payload includes a signal strength for each of the first plurality of BSSIDs, and the searching using the received BSSID combinations are based on the signal strengths.

In an embodiment, the determining the location of the device searches the second plurality of BSSIDs from a first time period.

In an embodiment, the geolocation payload further comprises a received internet protocol (IP) address of the device, wherein the database includes stored device IP addresses associated with the location data, and where-in the determining of the location of the device uses the received IP address.

In an embodiment, the determining of the location of the devices compares the received IP address to determine if it is within range of the stored device IP addresses.

In an embodiment, the location data stored in the database comprises previously stored location data of the first device, second device, or a combination thereof.

In an embodiment, the location data stored in the database comprises previously stored location data of the first device.

In an embodiment, the location data stored in the database comprises previously stored location data of a second device.

In an embodiment, the method further includes enforcing device rules based on the determined location of the device.

In an embodiment, the method further includes updating the database with the deter-mined location, the first plurality of BSSIDs and a timestamp of the geolocation payload.

In an embodiment, the method further includes verifying the determined location against a previous location of the first device.

In an aspect, there is provided a system for determining a location of a first device including a first device including a receiver for detecting a first plurality of BSSIDs, a processor for assembling a geolocation payload including the detected BSSIDs, and a transmitter for transmitting the geolocation payload; a database including a second plurality of BSSIDs and locations associated therewith; and a second device including a receiver and computer readable medium having instructions stored thereon that when executed, causes the second device to receive a geolocation payload from a first device having a receiver, the geolocation payload including a first plurality of basic service set identifications (BSSID) detected by the first device; and determine a location of the first device by searching, using the first plurality of BSSIDs, a database including a second plurality of BSSIDs and location data associated the second plurality of BSSIDs.

### BRIEF DESCRIPTION OF THE DRAWINGS

The present disclosure provides the following drawings, in which:

FIG. 1 is a representation of an environment in which the present disclosure may be deployed in accordance with some embodiments of the invention.

FIG. 2 is a representation of an alternative environment in which the present disclosure may be deployed in accordance with some embodiments of the invention.

FIG. 3 is a representation of another alternative environment in which the present disclosure may be deployed in accordance with some embodiments of the invention.

FIG. 4 is a flowchart of a method according to an embodiment of the present invention.

FIG. 5 is a flowchart depicting the searching and updating of a database according to an embodiment of the present invention.

FIG. 6 is a flowchart of a method according to another embodiment of the present invention.

### DESCRIPTION

The methods, processes, and systems described herein enable geolocation of a device based on wireless access points detected by the device. Geolocation of a device may be based on historical data of the device or multiple devices. Multiple wireless access points detected by the device may be grouped to reduce the size of the database, query times, and increase accuracy.

### Glossary

Access point (AP) or wireless access point (WAP): a device that creates a wireless local area network (WLAN), usually in an office or large building.

Application programming interface (API): a way for computer programs to communicate with each other. For example, an API can be used by a first program access geolocation services available through a second program.

Basic Service Set Identifier (BSSID): the MAC address of an AP. BSSID is often used to refer to devices that provides a connection to a network. Since a MAC address can be used to refer to identifiers of any device network device and not just those of APs, this disclosure uses BSSIDs to refer to MAC addresses of APs unless context dictates otherwise.

Geolocation: the identification of the geographical location of a device.

Media Access Control (MAC) address: a unique identifier assigned to a network interface controller of a device, such as an AP. MAC addresses are provided as six groups of two hexadecimal digits separated by hyphens, colons, or without a separator (e.g. 00:00:E6:02:37:F8)

WLAN: wireless local area network.

### EXEMPLARY EMBODIMENT

One embodiment involves looking up and finding one document in the location history database that has an AP list that overlaps with at least 3 items (that is, 3 APs that are currently detected by the device). If found, then the location recorded in that document is reused without calling a geolocation API. However, as the size of the geolocation history collection is usually huge, we have a way to return the result in a minimum response time.

Another embodiment involves storing the geolocation history records in a new collection with an identification (_id) that is the combination of 3 BSSIDs. In order to make sure that the identification is unique among 3 BSSIDs, we have to sort the BSSIDs into a list first.

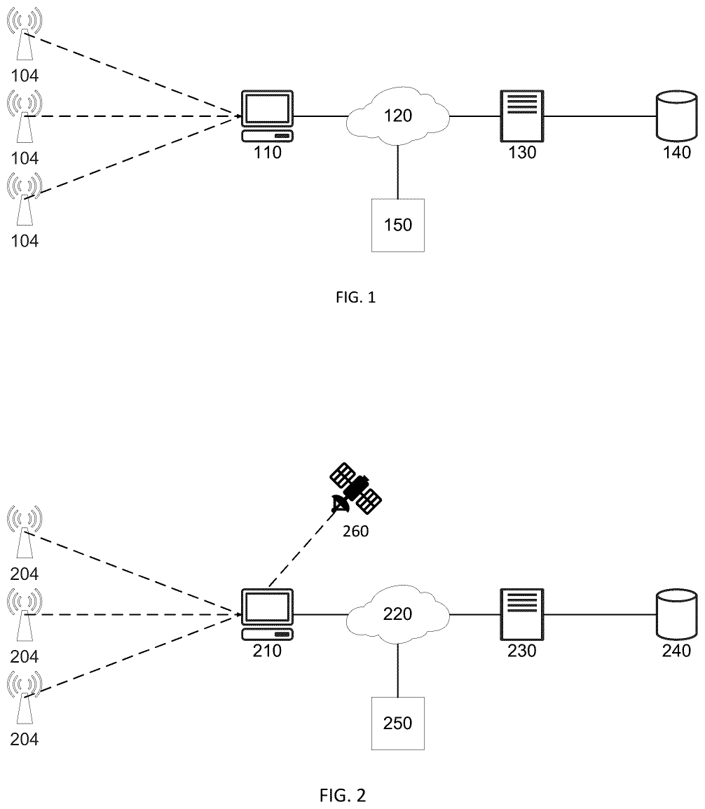

FIG. 1 illustrates an example of an environment 100 in which the geolocation of a client device can be determined, according to some embodiments. The example environment 100 can include one or more devices such as client device 110. The client device 110 includes receiver (not pictured) for use in collecting information for use in detecting the BSSIDs of access points (APs) 104 in its vicinity signals. The receiver may be a wireless receiver, a WIFI antenna, or the like. As depicted in FIG. 1, the client device 110 is. A client device can include a desktop computer, a laptop computer, a tablet computer, a smartphone, a set-top box, a smart watch, an internet of things device, and the like. Although illustrated using 3 APs, the client device 110 may detect fewer or more APs based on the number of APs in its vicinity and the strengths of their signals.

The client device 110 includes network hardware (not pictured), such as a transmitter, for communicating with a server 130 via a wide area network (WAN) 120, such as the Internet. Although shown as connecting directly to the WAN 120, the client device 110 may connect to the WAN through other methods, such as through one of the APs 104 detected by client device 110.

The server 130 can communicate with location database 140. Location database 140 includes historical location data of client devices 110 and BSSIDs detected by client device 110 at corresponding historical locations. Location database 140 may be stored on server 130 or remote therefrom.

The client device 110 can communicate with a geolocation server 150 using an API to obtain the location of the client device 110 where a location of client device 110 is not found on database 140.

FIG. 2 illustrates another example of an environment 200 in which the geolocation of a client device can be determined, according to some embodiments. The example environment 200 includes client device 210. The client device 210 includes a receiver for use in collecting information for use in BSSIDs of APs 204 in its vicinity. As noted above, the client device 210 may detect fewer or more APs based on the number of APs in its vicinity and the strengths of their signals.

The client device 210 can communicate with a server 230 via a wide area network (WAN) 220, such as the Internet. Although shown as connecting directly to the WAN 220, the client device 210 may connect to the WAN through other methods, such as through one of the APs 204 detectable by client device 210.

The server 230 can communicate with location database 240. Location database 240 includes historical location data of client device 210 and BSSIDs detected by client device 210 at corresponding historical locations. Location database 240 may be stored on server 230 or remote therefrom.

The client device 210 can communicate with a geolocation server 250 using an API to obtain the location of the client device 210 where a location of client device 210 is not found on database 240.

The client device 210 includes or pairs to a satellite navigation receiver capable of communicating with a global navigation satellite system (GNSS) 260 for determining its location. Typically such client devices include smart phones, but other client devices paired with satellite navigation receivers may also be suitable. Exemplary GNSS implementations include the Global Positioning System (GPS), Global Navigation Satellite System (GLONASS), BeiDou, and Galileo.

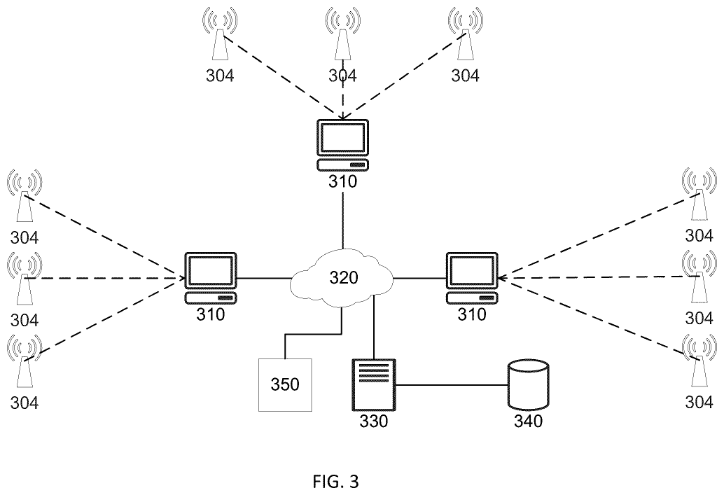

FIG. 3 illustrates yet another alternative example of an environment 300 in which the geolocation of a client device can be determined, according to some embodiments. The example environment 300 includes multiple client devices 310. Each client device 310 includes a receiver for use in collecting information for use in detecting the BSSIDs of APs 304 in its vicinity.

The client devices 310 can communicate with a server 330 via a wide area network (WAN) 320, such as the Internet. Although shown as connecting directly to the WAN 320, the client devices 310 may connect to the WAN through other methods, such as through one of the APs 304 detectable by client device 310. As noted above, the client device 310 may detect fewer or more APs based on the number of APs in its vicinity and the strengths of their signals.

The server 330 can communicate with location database 340. Location database 340 includes historical location data of all client devices 310 and BSSIDs detected by client devices 310 at corresponding historical locations. Location database 340 may be stored on server 330 or remote therefrom.

Each client device 310 can communicate with a geolocation server 350 using an API to obtain the location of the client device 310 where a location of client device 310 is not found on database 340.

Each client device 310 may connect asynchronously in the environment 300, such that different client devices 310 may be connected at once to each of the server 330, geolocation server 340, etc.

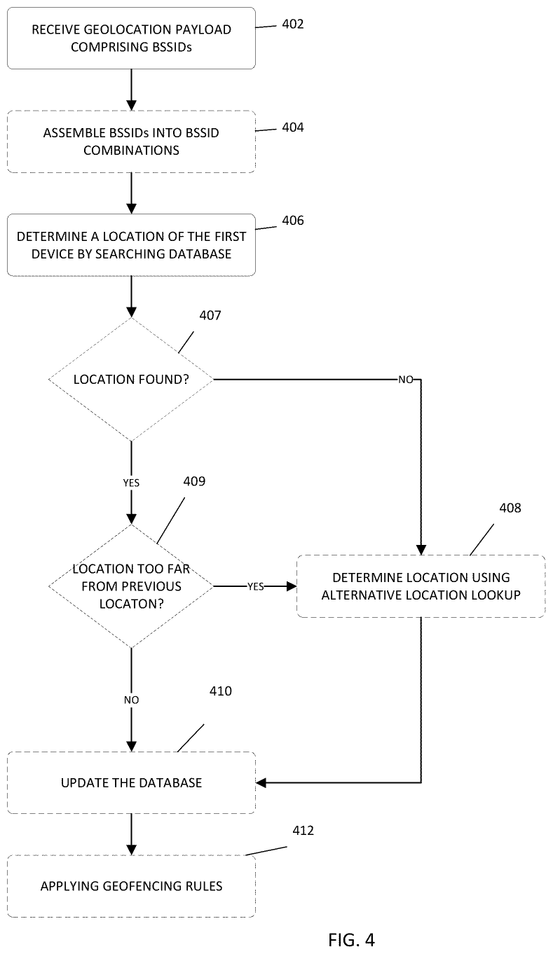

Turning now to FIG. 4, example operational procedures for implementing the examples are illustrated, according to some embodiments. At operation 402, a geolocation payload is received from a first device (e.g. a client device 110) having a receiver. The geolocation payload comprises a first plurality of BSSIDs detected by the first device. In some embodiments, the receiving of the payload is at the first device. Performing the lookup locally at the first device may speed up determination since it would eliminate transit times of the geolocation payload. However, this may require significant storage space on the first device (see, for example, the size of an exemplary database in Table 1, may not be able to access historical locations of other devices, reduce performance if the first client does not have sufficient computing power, and increase payload size if received BSSID combinations are transmitted to a server to duplicate the database or augment a secondary database. In some embodiments, the receiving is by a second device remote from the first device (e.g. a server 130, 230, 330).

At operation 406, the geolocation payload is used to determine a location of the first device by searching a database that includes a second plurality of BSSIDs and location data associated with the second plurality of BSSIDs. If one or more of the BSSIDs in the first plurality of BSSIDs matches the one or more of the BSSIDs in the second plurality of BSSIDs, the first device is determined as being located at the location associated with the one or more of the matching BSSIDs of the second plurality of BSSIDs. The confidence in the location may be increased with an increasing number of matches. This may be useful, for example, where a single physical AP broadcasts multiple SSIDs (e.g. virtual APs each with separate BSSIDs), or where BSSIDs. Matches to such BSSIDs may not increase the accuracy of the location, so increasing the number of matches may increase the likelihood that a BSSID from a different physical AP is matched. The speed of the operation may be increased by decreasing the number searches performed (e.g. by searching based on only a subset of the first plurality of BSSIDs). In some embodiments, at least 3, 4, 5, 6, 7, 8, 9 or 10 of the first plurality of BSSIDs have corresponding entries in the second plurality of BSSIDs. In some embodiments, 3, 4, 5, 6, 7, 8, 9 or 10 of the first plurality of BSSIDs have corresponding entries in the second plurality of BSSIDs. In some embodiments, 3 of the first plurality of BSSIDs have corresponding entries in the second plurality of BSSIDs.

In some embodiments, at operation 404, the BSSIDs are optionally assembled into received BSSID combinations, each received BSSID combination including a first number of BSSIDs from the first plurality of BSSIDs (see, e.g. FIG. 1). The first number of BSSIDs may be 2, 3, 4, 5, 6, 7, 8, 9, 10, or more. Increasing the first number of BSSIDs may improve the accuracy, confidence, or both, of the determination of the location. However, where the first number of BSSIDs is too high, the time required to perform the searches, the size of the dataset or both, may be increased. In embodiments where BSSIDs are assembled into received BSSID combinations, the second plurality of BSSIDs are stored as stored BSSID combination, each having the same number of BSSIDs as the received BSSIDs. The determination of the location at 406 searches using the received BSSID combinations for matches in the stored BSSID combination.

In some embodiments, the first number is at least 3, and each received BSSID combination includes at least 3 BSSIDs. In a preferred embodiment, the first number is 3. The use of 3 APs (such as 3 different physical APs) helps to reduce uncertainty in location. If locations of three known APs are provided, a location can be determined using signal strength as a proxy for distance from the particular location.

The number of received BSSID combinations depends on the number of BSSIDs in the first plurality of BSSIDs in the geolocation payload and the first number. For example, where the first plurality of BSSIDs has 20 BSSIDs and the first number is 3, there are 1140 (20 choose 3) received BSSID combinations.

In some embodiments, the first plurality of BSSIDs includes all BSSIDs detected by the first device. In some embodiments, the first plurality of BSSIDs is limited based on a predetermined number, signal strength, or both. Depending on the number of APs in the vicinity of the first device, the first device may detect a very large number of BSSIDs. Thus, it may be desirable to limit the number of BSSIDs included in the geolocation payload. For example, where the first number is 3, and the predetermined number of BSSIDs is 20, there are 1140 received BSSID combinations; where the predetermined number of BSSIDs is 30, there are 4060 received BSSID combinations; where the predetermined number of BSSIDs is 40, there are 9880 received BSSID combinations.

In some embodiments, predetermined number is selected to reduce the number of potential searches performed during the determination. In some embodiments, the predetermined number is between 10 and 30. In some embodiments, the predetermined number is 20.

In some embodiments, the BSSIDs selected for inclusion in the geolocation payload is based on the signal strength of the corresponding AP as detected by the first device. For example, only the BSSIDs of the APs with the strongest signals are included in the geolocation payload. This may be limited to the predetermined number described above. In some embodiments, only those BSSIDs of APs with a threshold signal strength are included.

In some embodiments, the database includes historical locations of the first device, and, optionally, a timestamp of the historical location. In some embodiments, the determination of the location first searches the database based on a first time period, for example, recent locations of the first device. If a location cannot be found in the first time period, then the search is expanded to locations in a second time period longer than the first time period.

In some embodiments, the database includes historical locations of additional devices (e.g. additional client devices 310).

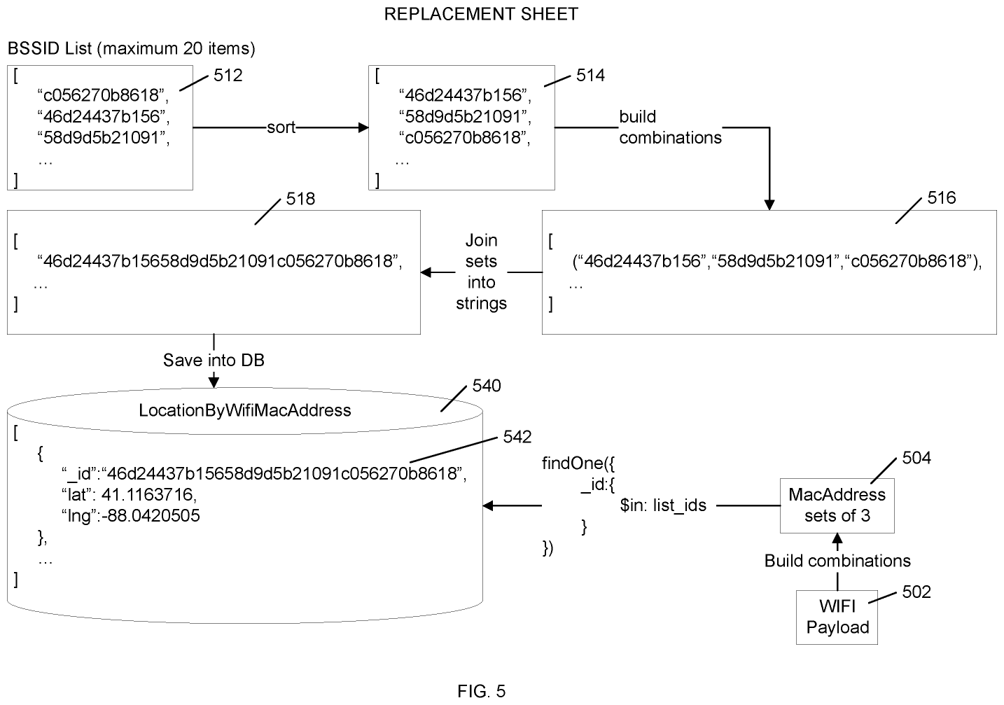

Turning now to FIG. 5, an embodiment of the updating of the database at operation 404 is provided for a group of BSSIDs 512 detected for a given longitude and latitude. The BSSIDs are then sorted into numerical order to provide a sorted array 514. The sorted array 514 is arranged into arrays for each combination of BSSIDs 516 that may be assembled from the array 516 (depicted with 3 BSSIDs in each combination). Each combination in each array 516 is joined into a separate string 518. Each joined combination 518 is related to the specific longitude and latitude and stored in the database 540 (such as database 140, 240, or 340) in a separate document 542. Later, when a server (such as server 130, 230, 330) receives, from the same device or another device, a geolocation payload (also referred to as a WIFI payload) 502 that includes BSSIDs detected by the device (such as at operation 402), it can create received BSSID combinations 504 from the geolocation payload 502 (such as at operation 404), similar to how the arrays of combinations of BSSIDs 516 are created (e.g. combinations of three BSSIDs from the detected BSSIDs). If one of the received BSSID combinations 504 matches a combined document entry 542 in the database 540 (such as at operation 407), the corresponding longitude and latitude can be retrieved from the document 542 without having to call a geolocation API.

TABLE 1 shows results of an exemplary database, e.g. in Collection: LocationByWifiMacAddress

TABLE 1

| | |
|---|---|
| Number of documents | 490, 510, 900 |
| Size | 45.1 GB |
| Number of | 1140 (for 20 BSSIDs) |
| combinations | |
| Query time | 0.879 s |

This shows that for 20 BSSIDs that are detected, there are 1140 combinations of three BSSIDs that can be selected from those 20. It also shows that a typical query time is below a second.

In other embodiments, groups of four or more BSSIDs (or APs) may be used instead of three. By increasing the number of APs, the accuracy, confidence, or both, maybe increased, but the database size, the query time, or both may be reduced.

The BSSIDs (e.g. 3 BSSIDs) may be combined in another way for storage in the database. For example, in some embodiments, the BSSIDs are stored as individual arrays of BSSID combinations 506 and not joined into strings. In such embodiments, the document 512 includes the array of BSSIDs, and, optionally, relative signal strengths of the BSSIDs at the particular location.

Turning back to FIG. 4, in some embodiments, at operation 410, the database is updated with documents including the determined location, the first plurality of BSSIDs and a timestamp of the geolocation payload. In some embodiments, the first plurality is saved in the form of the received BSSID combination in a document that includes the determined location, and the timestamp of the geolocation payload. In some embodiments, documents with unique BSSID combinations are saved to the database rather than duplicating BSSID combinations and locations, to reduce storage requirements. In some embodiments, the document that includes a matched BSSID combination is updated with the timestamp of the document. In other embodiments, the particular received BSSID combination with a matching stored BSSID combination in a pre-existing document is saved in a new document. In some embodiments, each received BSSID combination is combined into a single string. In some embodiments, each received combination BSSID is stored as an array.

In some embodiments, at operation 407, if a location is found at operation 406, then the determined location can be used as further set out in the method. However, if a location cannot be determined based on the database, an alternative location lookup is optionally performed at operation 408. Alternative location lookups include using an API to determine the location of the first device, such as using a geolocation API (such as one offered by Googe, Baidu, etc.), using a satellite navigation receiver to receive a position using a GNSS, using a location of the OS, or a combination thereof. For example, a second device that received the geolocation payload may send a request to the first device for the position using the GNSS or location of the OS, if the first device is equipped with such information. Typically, requests for the use of satellite navigation receiver is limited due to higher power consumption, time taken to synchronize with GNSS, and availability of satellite navigation receivers (e.g. not typically equipped with laptop or desktop devices). Further, with OS location, reliability may be limited because they may be manually input by a user. Further still, geolocation API calls may incur costs, which are magnified when managing a fleet of devices. As such, use of BSSIDs is preferred.

In some embodiments, the determined location is optionally verified at operation 409 against a previous location of the first device, such as the last known location. In some embodiments, the previous location is stored in the database. If there is a seemingly unreasonable distance between the location of the first device based on the timestamp of the geolocation payload and the previous location based on its timestamp, then an inaccurate location may have been determined. In such cases, the location may optionally be determined or verified at operation 408. In some embodiments, the determined location at operation 408 is compared against the determined location at 406. If determined locations are proximate to one another, then the location may be presumed to be accurate. If however, the locations determined at 406 and 408 are not proximate to one another, then the location may be erroneous. In such cases, in some embodiments, an alternative location lookup may be performed, the database may be updated to remove the association of that location with the particular BSSIDs, the case is logged for further investigation, or a combination thereof.

In some embodiments, the geolocation payload includes internet protocol (IP) addresses. In some embodiments, historical IP addresses are associated with each location and the second plurality of BSSIDs stored on the database. IP addresses may, in some embodiments, be used to filter requests from previously unknown locations. For example, the IP address may be used as error verification by determining whether the IP address been previously associated with any location. If the IP address of the geographic payload does not match any IP address stored on the database, this may indicate that the first device has not been at such location and obviate any need to search the BSSIDs. In some embodiments, the matching of the IP address of the geolocation payload need not be an exact match to an IP address of the database, but one within a certain IP range. For example, certain internet service providers will not assign a static IP to a particular device, but will dynamically assign one. In such cases, a range of IPs may be assigned at the same location based on subnetting practices. In other embodiments, the IP address of the geolocation payload must be identical to an IP of the previous location. In some embodiments, the IP address from the geolocation payload can be used to determine or improve the confidence of the location of the first device based on the database.

In some embodiments, the determined location is optionally used to enforce geofencing rules at operation 412. In some embodiments, the determined location is used to provide geotags for additional data received from the first device. In some embodiments, the determined location is used to deliver location-based services, such as targeted advertisements, navigation services, tracking, search results, to provide data for analysis and research, or a combination thereof.

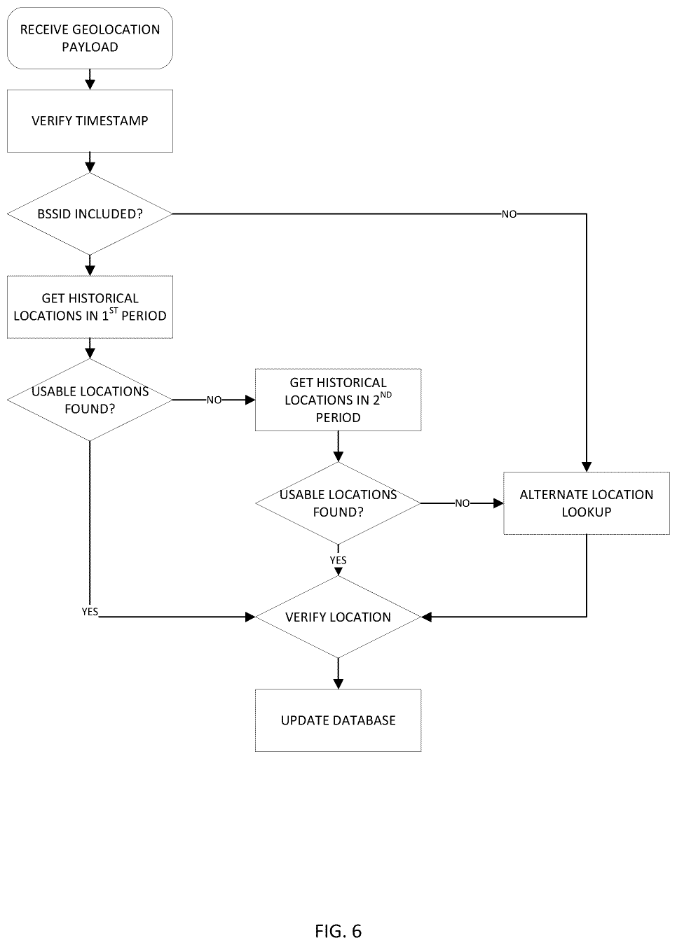

Turning now to FIG. 6, an alternate embodiment of the method is presented. At 602, a geolocation payload is received. The geolocation payload includes a timestamp, and, optionally, BSSIDs, GNSS data, OS location data, and IP addresses.

At 604, the timestamp is used to perform error checking. For example, if the timestamp is unavailable, has a time that is before a previous entry, or ahead of the receiving device.

At 606, the geolocation is payload is inspected to verify whether it includes BSSIDs. If the geolocation payload is determined to include BSSIDs, then the database is searched to determine whether historical locations with those BSSIDs are available in a first time period at 608 (e.g. a recent locations, such as the past 24 hours). At 610, if historical locations are found in the 1^{st} time period, then the location is verified at 612 to determine whether determined location is within a predetermined radius of the last known location of the device. If the device is within the predetermined radius, then database is updated with the new BSSIDs detected by the device. If the device is not within the predetermined radius, then an alternative location lookup is initiated to verify that the location in the databases is still accurate.

If, at 610, no historical locations are found in the 1^{st} time period, then the search is broadened to include historical locations found in a 2^{nd} time period. At 614, if a usable location is found in the 2^{nd} time period, then the location is verified at 612. If no usable location is found in the second time period, then the location proceeds to an alternate location lookup at 616.

If no BSSIDs are included in the geolocation payload at 606, an alternate location lookup is performed at 616.

After the location is verified at 612, the database is updated at 618 with the location and times of the new geolocation payload, and optionally the BSSIDs, and IP address.

A description of an embodiment with several components or features does not imply that any particular component and/or feature is required. On the contrary, a variety of optional components have been described to illustrate the wide variety of possible embodiments of the present invention(s).

It will be readily apparent that the various methods and algorithms described in this disclosure may be implemented by appropriately programmed computers and/or computing devices. Typically a processor will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. Thus, embodiments are not limited to any specific combination of hardware and software.

Accordingly, a description of a process likewise describes at least one apparatus for performing the process, and likewise describes at least one computer-readable medium and/or computer-readable memory for performing the process. The apparatus that performs a described process may include components and/or devices (e.g., a processor, input and output devices) appropriate to perform the process. A computer-readable medium may store program elements and/or instructions appropriate to perform a described method.

1. A method comprising:
receiving a geolocation payload from a first device having a receiver, the geolocation payload comprising a first plurality of basic service set identifications (BSSID) detected by the first device;
determining a location of the first device by searching, using the first plurality of BSSIDs, a database including a second plurality of BSSIDs and location data associated with the second plurality of BSSIDs.

2. The method of claim 1 further comprising:
determining the location using an alternative location lookup if the search does not find location data in the database based on the first plurality of BSSIDs.

3. The method of claim 2, wherein the alternative location lookup is a geolocation API, a location determined using global navigation satellite system (GNSS), or a location of the OS.

4. The method of claim 1, further comprising:
assembling the first plurality of BSSIDs into received BSSID combinations, each received BSSID combination including a first number of BSSIDs from the first plurality of BSSIDs,
wherein the second plurality of BSSIDs are stored as stored BSSID combinations, each stored BSSID combination including the first number of BSSIDs from the second plurality of BSSIDs, and
wherein the determining of the location searches using the received BSSID combinations for matches in the stored BSSID combinations.

5. The method of claim 4, wherein the first number is at least 3.

6. The method of claim 4, wherein the determining of the location of the device searches the database using the received BSSID combinations until at least one received BSSID combination is found.

7. The method of claim 4, wherein the geolocation payload includes a signal strength for each of the first plurality of BSSIDs, and the searching using the received BSSID combinations are based on the signal strengths.

8. The method of claim 1, wherein the determining the location of the device searches the second plurality of BSSIDs from a first time period.

9. The method of claim 1, wherein the geolocation payload further comprises a received internet protocol (IP) address of the device, wherein the database includes stored device IP addresses associated with the location data, and wherein the determining of the location of the device uses the received IP address.

10. The method of claim 9, wherein the determining of the location of the devices compares the received IP address to determine if it is within range of the stored device IP addresses.

11. The method of claim 1, wherein the location data stored in the database comprises previously stored location data of the first device, a second device, or a combination thereof.

12. The method of claim 1, wherein the location data stored in the database comprises previously stored location data of a second device.

13. The method of claim 1, wherein the location data stored in the database comprises previously stored location data of a second device.

14. The method of claim 1, further comprising enforcing device rules based on the determined location of the device.

15. The method of claim 1, further comprising updating the database with the determined location, the first plurality of BSSIDs and a timestamp of the geolocation payload.

16. The method of claim 1, further comprising verifying the determined location against a previous location of the first device.

17. A system for determining a location of a first device comprising:
a first device comprising a receiver for detecting a first plurality of BSSIDs, a processor for assembling a geolocation payload comprising the detected BSSIDs, and a transmitter for transmitting the geolocation payload;
a database comprising a second plurality of BSSIDs and locations associated therewith; and
a second device comprising a receiver and computer readable medium having instructions stored thereon that when executed, causes the second device to:
receive a geolocation payload from a first device having a receiver, the geolocation payload comprising a first plurality of basic service set identifications (BSSID) detected by the first device; and
determine a location of the first device by searching, using the first plurality of BSSIDs, a database including a second plurality of BSSIDs and location data associated the second plurality of BSSIDs.
